(19) United States
(12) Patent Application Publication
(10) Pub. No.: US 2006/0226225 A1
(43) Pub. Date: Oct. 12, 2006

(54) Multifunctional light beam pointer

(76) Inventors: Ching-Horng Hsiao, Shalu Township (TW); Monica Cheng, Taipei (TW); James Lee, Toucheng Township (TW); Cheng-Hsiung Huang, Sijhih City (TW)

Correspondence Address: Raymond Sun, 12420 Woodhall Way, Tustin, CA, 92782, US

(21) Appl. No.: 11/165,470

(22) Filed: Jun. 22, 2005

(30) Foreign Application Priority Data
Apr. 8, 2005 (TW) 94111113

(51) Int. Cl. G06K 7/10

(52) U.S. Cl. 235/454; 235/472.03

(57) ABSTRACT

A multifunctional light beam pointer includes a case that houses a memory, a data transmission interface, a memory controller, and a laser light source. The memory controller is coupled to the memory and the data transmission interface for transferring data through the data transmission interface for storage in the memory. The laser light source emits a laser beam from the pointer.

### BACKGROUND OF THE INVENTION

1. Field of the Invention

The present invention relates to a light beam pointer, and in particular, to a multifunctional light beam pointer that integrates a laser pointer with a data storage circuit.

2. Description of the Prior Art

Laser pointers are commonly used as aids in teaching or making presentations. Since a laser beam has the characteristic of parallel transmission and its illumination does not decrease drastically over transmission distance, people have widely used laser beams emitted from laser pointers to point at objects on a line or on a monitor for teaching or presentation purposes. Instructors or presenters can therefore move around a room without being restricted to the positions of objects or monitors.

To facilitate the ease of transportation and to increase variety in use, a number of laser pointers have been provided with different functions and appearances. As a non-limiting example, U.S. Pat. No. 5,617,304 discloses a ballpoint pen integrated with a laser pointer, which, apart from the ease of transportation, can also be used as a pen for writing.

With recent advances in computer technology, the digitalization of information has become an inevitable consequence. Nowadays, most presentations are made using computer equipment and digitally-stored information. Thus, there is a need to enhance the resources available for presentation and teaching applications.

### SUMMARY OF THE INVENTION

It is an object of the present invention to enhance the resources available for teaching and presentation purposes.

It is another object of the present invention to provide a multifunctional light beam pointer which integrates a memory capable of storing digital information into an easily transportable laser pointer.

It is yet another object of the present invention to provide a multifunctional light beam pointer having a data transmission interface to access data so as to facilitate the users' ease in storing and retrieving data.

It is a further object of the present invention to provide a multifunctional light beam pointer which is capable of using the power provided by the data transmission interface to charge a rechargeable battery in the pointer.

It is yet another object of the present invention to provide a multifunctional light beam pointer having refills for writing or operating a personal digital assistant (PDA).

It is yet another object of the present invention to provide a multifunctional light beam pointer having a white light-emitting diode (LED) to provide lighting for users.

In order to accomplish the objects of the present invention, the present invention provides a multifunctional light beam pointer. In one embodiment of the present invention, the multifunctional light beam pointer includes a case that houses a memory, a data transmission interface, a memory controller, and a laser light source. The memory controller is coupled to the memory and the data transmission interface for transferring data through the data transmission interface for storage in the memory. The laser light source emits a laser beam from the pointer.

According to another embodiment of the present invention, the multifunctional light beam pointer has a case which houses a memory, a data transmission interface, a memory controller, a light source, a rechargeable battery, and a charging circuit. The memory controller is coupled to the memory and the data transmission interface for transferring data through the data transmission interface for storage in the memory. The light source generates a light. The rechargeable battery is coupled to the light source. The charging circuit is coupled to the battery, and connected with an external power through the data transmission interface to charge the battery.

### BRIEF DESCRIPTION OF THE DRAWINGS

FIG. 1 is a perspective view of a multifunctional light beam pointer in accordance with one embodiment of the present invention.

FIG. 2 is an exploded perspective view of the pointer of FIG. 1.

FIG. 3 is an exploded perspective view showing the upper and lower barrels of the pointer of FIG. 1.

FIG. 4 is a schematic block circuit diagram of the circuit board in FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

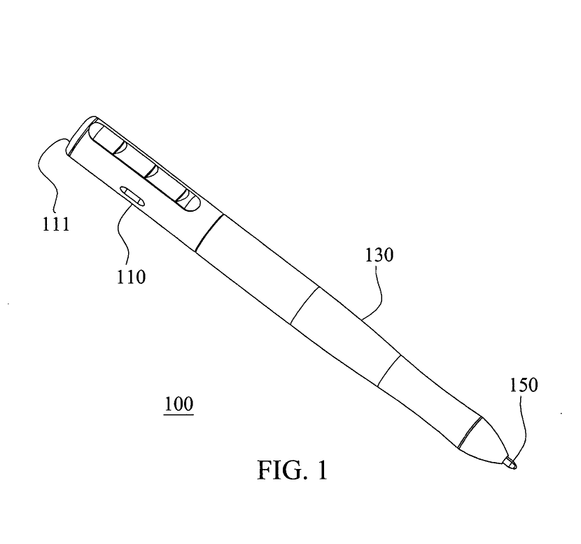

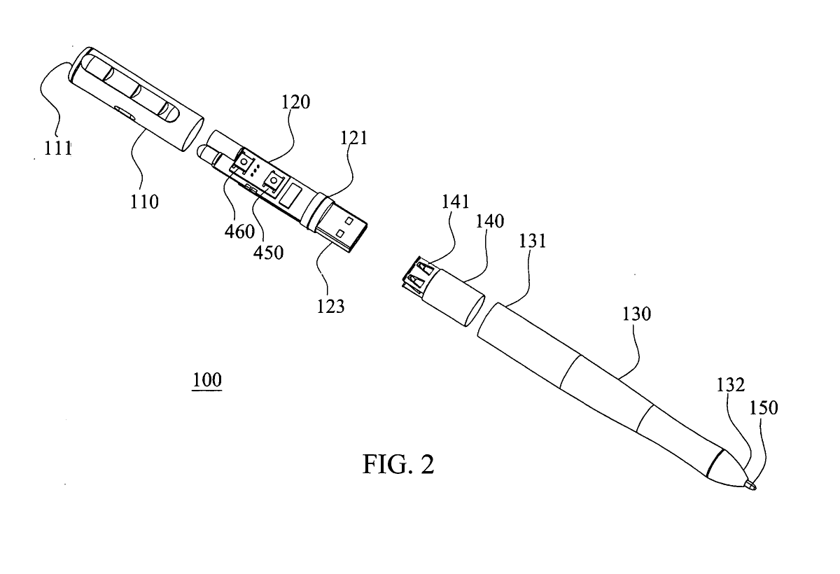

FIGS. 1 and 2 illustrate a multifunctional light beam pointer 100 according to one embodiment of the present invention, which includes an upper barrel 110, a circuit board 120 arranged inside the upper barrel 110, a lower barrel 130, and a clamping element 140 arranged at the upper end 131 of the lower barrel 130. The upper barrel 110 and the lower barrel 130 form a case for the pointer 100. A touch refill 150 (which is capable of operating a PDA) and/or a writing refill (not shown) can be retained inside the lower barrel 130. A conventional rotation-driven mechanism (not shown) can be provided at the upper end 131 of the lower barrel 130 to enable a user to selectively push the touch refill 150 or the writing refill out of the lower end 132 of the lower barrel 130 for operating a PDA or for writing.

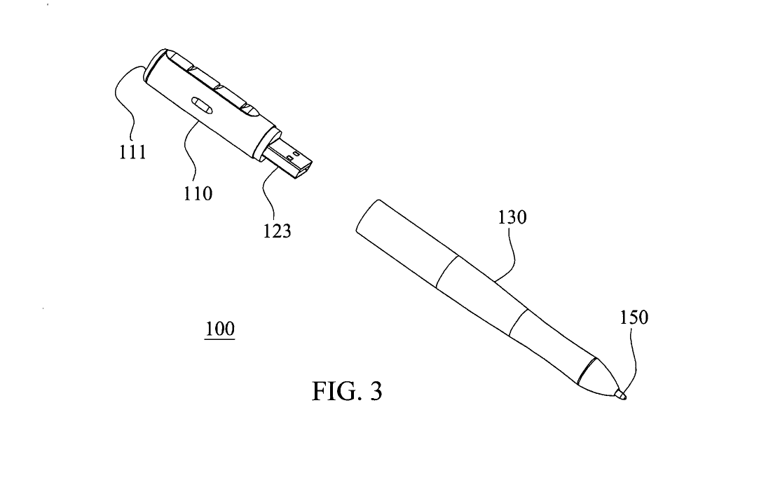

The circuit board 120 is secured inside the upper barrel 110 by a fixing part 121. The clamping element 140 is secured in the upper end 131 of the lower barrel 130 by a press fit. Other conventional securing mechanisms (e.g., screws, snap-fits, etc.) can also be used for securing the fixing part 121 and the upper barrel 110, and for securing the clamping element 140 and the lower barrel 130. FIG. 3 illustrates the assembled lower barrel 130 and the assembled upper barrel 110.

Referring to FIGS. 2 and 3, when the circuit board 120 is secured on the upper barrel 110 by the fixing part 121, the USB interface 123 that is connected with the circuit board 120 will protrude out of the bottom end of the upper barrel 110. In addition, the clamping element 140 is retained completely inside the upper end 131 of the lower barrel 130. Consequently, when the upper barrel 110 is connected to the lower barrel 130, the USB interface 123 can be secured to a clamping clip 141 provided on the clamping element 140, thereby preventing the USB interface 123 from being detached from the pointer 100.

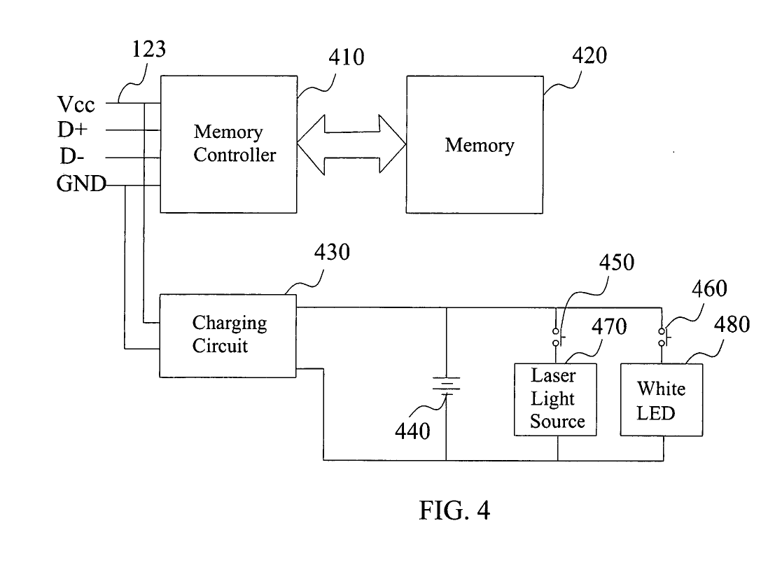

FIG. 4 is the schematic block circuit diagram of the circuit board 120. The Vcc, D+, D−, and GND (Ground) pins of the USB interface 123 are coupled to a memory controller 410, which is in turn coupled to a memory 420. The Vcc and GND pins of the USB interface 123 are also coupled to a charging circuit 430 to provide power to the charging circuit 430 for charging a rechargeable battery 440. The rechargeable battery 440 is coupled to a laser light source 470 and a white light-emitting-diode 480 by push-button switches 450 and 460, respectively (see also FIG. 2), which can be used to control the light beams produced by the laser light source 470 and the white light-emitting-diode 480, respectively.

When a user wishes to download data (e.g., for use in a presentation) into the memory 420, the upper barrel 110 can be pulled out from the lower barrel 130 and the USB interface 123 can be inserted into the USB port of a first personal computer. Consequently, the data stored in the first personal computer can be transferred and saved in the memory 420 through the control of the memory controller 410. When the user arrives at the location of the presentation, he or she can, with a similar connection of the memory 420 with the USB port of a second personal computer, transfer the data stored in the memory 420 to the second personal computer through the control of the memory controller 410, so that the data can now be used for the presentation (in connection with the second personal computer).

During a presentation, the push-button switch 450 can be pressed to supply the laser light source 470 with power from the rechargeable battery 440, so that the laser light source 470 will produce a laser beam from the light exit window 111 of the upper barrel 110 for use in directing the audience to an intended target on a screen or monitor. Alternatively, when the user wishes to view documents or other materials during the presentation in a dark room where the lights have been turned off, the user can press the push-button 460 to supply the white light-emitting-diode 480 with power from the rechargeable battery 440, thereby causing the white light-emitting-diode 480 to emit a white light as a light source for reading the documents or other materials. Both push buttons 450, 460 can be turned on at the same time to have the white light-emitting-diode 480 and the laser light source 470 operating at the same time.

When a user wishes to charge the rechargeable battery 440, the upper barrel 110 can be pulled out from the lower barrel 130 and the USB interface 123 can be inserted into the USB port of a personal computer. The power from the personal computer can be transferred over the USB interface 123 to recharge the rechargeable battery 440.

Preferred embodiments of the memory 420 and the memory controller 410 can include a flash memory and a flash memory controller, respectively. The laser light source 470 can be embodied in the form of a laser module that is capable of producing approximately parallel beams. The rechargeable battery 440 can also be replaced with a conventional (non-rechargeable) battery to reduce the cost of the charging circuit 430. In addition, although the present invention illustrates the pointer 100 as being provided with a touch refill 150, a writing refill, and a rotation-driven mechanism, it is also possible to omit these components and provide the lower barrel 130 with a simpler construction.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A multifunctional light beam pointer, comprising:
a memory;
a data transmission interface;
a memory controller coupled to the memory and the data transmission interface for transferring data through the data transmission interface for storage in the memory;
a laser light source that emits a laser beam from the pointer; and
a case that accommodates the memory, the data transmission interface, the memory controller, and the laser light source.

2. The pointer of claim 1, wherein the data transmission interface is a universal serial bus (USB) interface.

3. The pointer of claim 2, further comprising:
a rechargeable battery coupled to the laser light source; and
a charging circuit coupled to the battery, and further connected with an external power through the USB interface to charge the rechargeable battery.

4. The pointer of claim 1, wherein the case is embodied in the form of a pen.

5. The pointer of claim 4, wherein the pen comprises:
an upper barrel that accommodates the memory, the data transmission interface, the memory controller, and the laser light source;
a lower barrel having an upper end and a lower end, the lower barrel provided with a refill and a rotation-driven mechanism which pushes the refill to protrude from the lower end; and
a clamping element arranged in the upper end to secure the data transmission interface, and to connect the upper barrel with the lower barrel.

6. The pointer of claim 5, wherein the refill comprises either a touch refill or a writing refill.

7. The pointer of claim 1, further comprising a white light-emitting diode (LED).

8. The pointer of claim 1, further comprising a push-button switch coupled to the laser light source to control the generation of the laser beam.

9. The pointer of claim 1, wherein the memory is a flash memory.

10. A multifunctional light beam pointer, comprising:
a memory;
a data transmission interface;
a memory controller coupled to the memory and the data transmission interface for transferring data through the data transmission interface for storage in the memory;
a light source that generates a light for the pointer;
a rechargeable battery coupled to the light source;
a charging circuit coupled to the battery, and connected with an external power through the data transmission interface to charge the battery; and
a case which accommodates the memory, the data transmission interface, the memory controller, the light source, the battery, and the charging circuit.

11. The pointer of claim 10, wherein the data transmission interface is a universal serial bus interface.

12. The pointer of claim 10, wherein the case is embodied in the form of a pen.

13. The pointer of claim 12, wherein the pen comprises:
an upper barrel that accommodates the memory, the data transmission interface, the memory controller, the light source, the battery, and the charging circuit;
a lower barrel having an upper end and a lower end, the lower barrel provided with a refill and a rotation-driven mechanism which pushes the refill to protrude from the lower end; and
a clamping element arranged in the upper end to secure the data transmission interface, and to connect the upper barrel with the lower barrel.

14. The pointer of claim 13, wherein the refill comprises either a touch refill or a writing refill.

15. The pointer of claim 10, wherein the light source is a laser light source that generates a laser beam.

16. The pointer of claim 15, further comprising a white light-emitting diode (LED).

17. The pointer of claim 15, further comprising a push-button switch coupled to the laser light source to control the generation of the laser beam.

18. The pointer of claim 10, wherein the memory is a flash memory.

19. The pointer of claim 10, wherein the light source is a white light-emitting diode (LED).
